(19) United States
(12) Patent Application Publication
(10) Pub. No.: US 2023/0324040 A1
(43) Pub. Date: Oct. 12, 2023

(54) VARIABLE-DIRECTION INJECTOR TIP AND BURNER INCORPORATING THE SAME

(71) Applicant: John Zink Company, LLC, Tulsa, OK (US)

(72) Inventors: Vladimir Lifshits, Napa, CA (US); Matt Whelan, Sacramento, CA (US); Aaron Nackos, Tulsa, OK (US)

(21) Appl. No.: 18/043,216

(22) PCT Filed: Sep. 16, 2021
(86) PCT No.: PCT/IB2021/058467

§ 371 Date: Feb. 27, 2023

Related U.S. Application Data
(60) Provisional application No. 63/090,726, filed on Oct. 13, 2020.

(51) Int. Cl. F23C 5/06; G05D 3/12

(52) U.S. Cl. CPC F23C 5/06; G05D 3/12

(57) ABSTRACT

A variable-direction burner tip is coupled to a first actuator that, when actuated, alters a firing direction of the respective burner tip. A respective flexible hose may couple a fuel input to each burner tip to accommodate rotation of the respective burner tip. In a burner incorporating one or more variable-direction burner tips, the burner includes a burner throat having one or more burner throats therein, the burner throats being sized and shaped to accommodate variation in firing direction by at least one burner tip positioned within each of the burner throats.

### RELATED APPLICATIONS

This application claims priority to U.S. Provisional Patent Application No. 63/090,726, filed on Oct. 13, 2020, which is incorporated herein by reference in its entirety.

### BACKGROUND

Combustion systems operate by converting fuel and air into thermal energy within a process heater. The combustion system includes one or more burners mounted on the system floor, walls, and/or ceiling. Input air is mixed with input fuel and ignited to produce thermal energy. The input fuel travels through a fuel line, and is injected into a furnace chamber via one or more burner tips. The shape of the flame is important within the combustion system for consistent and designed heat transfer to specific locations of the combustion system. Further, the flame shape varies significantly based on burner design methods to mix fuel and air for suppression of pollutant emissions, thus, the shape of the flame effects emissions emitted from the combustion system. Currently, the shape of the flame is typically static (e.g., not controllable, or limited control) because the burner is designed for a specific function and flame shape. There exists a need for a burner having variable-direction burner tip(s) to change the flame shape.

### SUMMARY

Combustion systems are meticulously designed using known configurations of burners, and for a typical operating profile. However, once installed, the installation may not be exactly to specifications, or the use may vary over time. Therefore, there exists a need to allow for varied operating conditions within the combustion system. The present systems and methods acknowledge that the burner flame shape is of importance to the internal heat profile of the combustion system. Accordingly, the present systems and methods provide a variable-direction burner tip and burner incorporating the same. This provides the advantage that the shape of the flame produced by the burner incorporating the variable-direction burner tip is modifiable during operation of the combustion system. This allows for accommodation of various operating conditions, as well as imperfect installations.

In a first aspect, a burner having variable-direction burner tip, includes a burner throat having one or more burner throats therein, the burner throats being sized and shaped to accommodate variation in firing direction by at least one burner tip positioned within each of the burner throats. In the first aspect, each the burner tip is coupled to a first actuator that, when actuated, alters a firing direction of the respective burner tip. In the first aspect, the burner further includes a respective flexible hose coupling a fuel input to each burner tip to accommodate rotation of the respective burner tip.

In a second aspect, a variable-direction burner tip, includes an actuator. In the second aspect, the burner tip further includes a burner tip. In the second aspect, the burner tip further includes a linkage coupled between the actuator and the burner tip that, in response to actuation of the actuator, alters the firing direction of the burner tip. In the second aspect, the burner tip further includes a flexible hose directly or indirectly coupling the burner tip to a fuel input coupler.

### BRIEF DESCRIPTION OF THE FIGURES

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 depicts an example system of a process heater with one or more burners incorporating one or more variable-direction burner tip, in embodiments.

FIG. 2 depicts an example variable-direction burner tip assembly, in embodiments.

FIG. 3 depicts the variable-direction burner tip assembly angled to a first firing direction.

FIG. 4 depicts the variable-direction burner tip assembly angled to a second firing direction.

FIG. 5 depicts a portion of the variable-direction burner tip assembly in further detail, showing the support brace coupling to the hinge where the burner tip rotates, in embodiments.

FIG. 6 depicts the variable-direction burner tip assembly including a support brace for supporting a hinge thereof in further detail, in embodiments.

FIG. 7 depicts the rotation indicator of FIG. 2 in further detail, in embodiments.

FIG. 8 depicts a front view of the exit port of a burner incorporating at least one of the variable-direction burner tip assembly of FIG. 2, in embodiments.

FIG. 9 depicts a method for changing a flame shape within a combustion system using a variable-direction burner tip and burner incorporating the same, in embodiments.

### DETAILED DESCRIPTION OF THE EMBODIMENTS

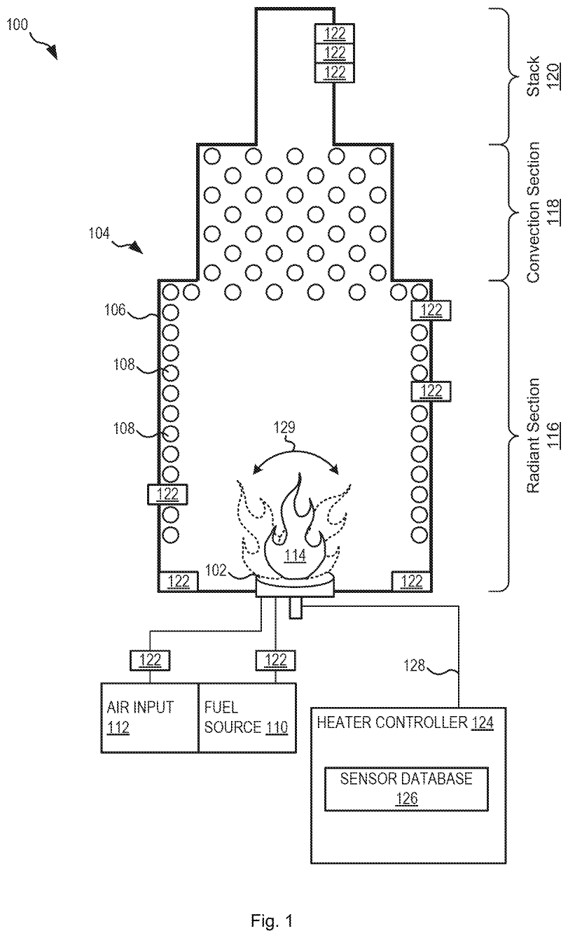

FIG. 1 depicts an example system 100 of a process heater with one or more burners 102 incorporating one or more variable-direction burner tip, in embodiments. The system 100 includes a heater 104 that is heated by one or more the burners 102 located in the housing 106 thereof. Heater 104 can have any number of burners 102 therein, each operating under different operating conditions (as discussed in further detail below). Moreover, although FIG. 1 shows a burner located on the floor of the heater 104, one or more burners may also be located on the walls and/or ceiling of the heater 104 without departing from the scope hereof (indeed, heaters in the industry often have over 100 burners). Further, the heater 104 may have different configurations, for example a box heater, a cylindrical heater, a cabin heater, and other shapes, sizes, etc. as known in the art.

Burner 102 provides heat necessary to perform chemical reactions or heat up process fluid in one or more process tubes 108 (not all of which are labeled in FIG. 1. Any number of process tubes 108 may be located within the heater 104, and in any configuration (e.g., horizontal, vertical, curved, off-set, slanted, or any configuration thereof). Burner 102 is configured to combust a fuel source 110 with an oxidizer such as air input 112 to convert the chemical energy in the fuel into thermal energy 114 (e.g., a flame). This thermal energy 114 then radiates to the process tubes 108 and is transferred through the process tubes 108 into a material therein that is being processed. Accordingly, the heater 104 typically has a radiant section 116, a convection section 118, and a stack section 120. Heat transfer from the thermal energy 114 to the process tubes 108 primarily occurs in the radiant section 116 and the convection section 118.

Throughout the heater 104 are a plurality of sensors that transmit data to a process controller 124. The sensor data is stored in a sensor database 126. The sensors 122 include a variety of sensors known in the art, such as O₂ sensor, NOX sensor, CO sensor, pressure sensor, air-flow sensors, fuel-flow sensors, temperature sensors, laser-based sensors, optical-based sensors, etc. The process controller 124 is a distributed control system (DCS) (or plant control system (PLC) used to control various systems throughout the system 100, including fuel-side control (e.g., control of components associated with getting fuel source 110 into the heater 104 for combustion therein), air-side control (e.g., control of components associated with getting air source 112 into the heater 104), internal combustion-process control (e.g., components associated with managing production of the thermal energy 114, such as draft within the heater 104), and post-combustion control (e.g., components associated with managing the emissions after production of the thermal energy 114 through the stack section 120). The process controller 124 typically includes many control loops, in which autonomous controllers are distributed throughout the system 100 (associated with individual or multiple components thereof), and including a central operator supervisory control. The control signals generated by the process controller 124 are based on the data provided by the sensors 122, and external data such as weather data, etc.

In addition to the draft within the heater, burner geometry plays a critical role in managing the thermal energy 114 produced in the heater 104. Typically, burners are specifically designed to have a static geometry that does not change (e.g., burner shape is consistent to the designed configuration, (except for wear and tear impact such as tip plugging, tip burn-off, failing refractory, etc.). The present embodiments address the realization operating conditions change within the heater 104. These changing operating conditions make it desirable to change the flame shape and/or direction (represented in FIG. 1 by arrow 129 and dashed flames of thermal energy) of a given burner to adjust the location of the generated thermal energy 114. This also allows for varying conditions at the process tubes 108 to result in more efficient operation of the heater 104. The control of the flame shape/direction is implemented by an actuator 130, which may be a manual actuator, or may be an electronic actuator controlled by process controller 124, as discussed in further detail below.

FIG. 1 is shown with burners located in a combustion system, where the input fuel source 110 is a gas or liquid fuel source. However, it should be appreciated that the embodiments herein may be used in other injector-type systems, such as flares. In such embodiments, the fuel source 110 may be another type of fluid, such as gas, liquid, or steam. Thus, the embodiments discussed herein encompass a fluid source (e.g., fuel of any composition, or steam, etc.) that is injected.

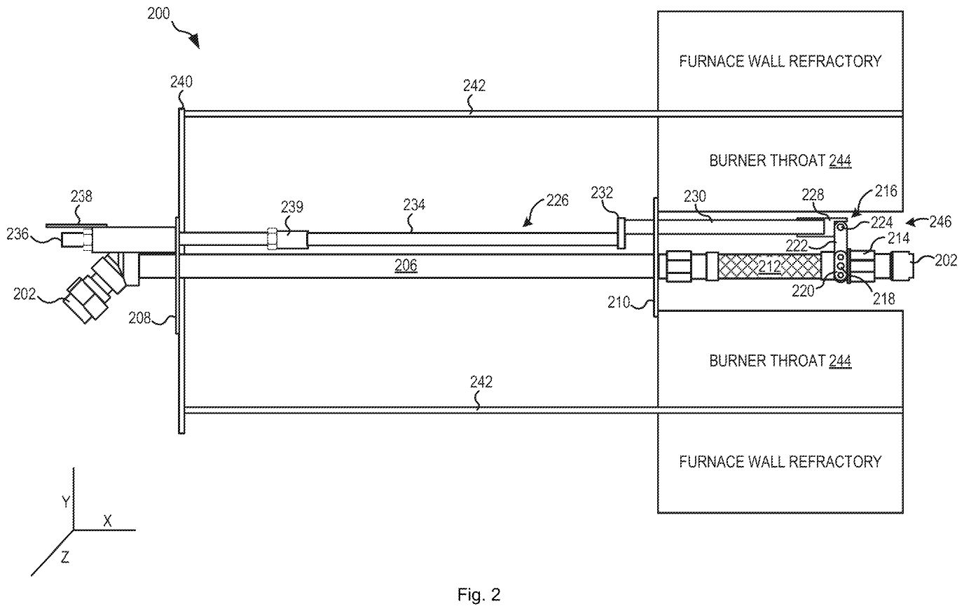

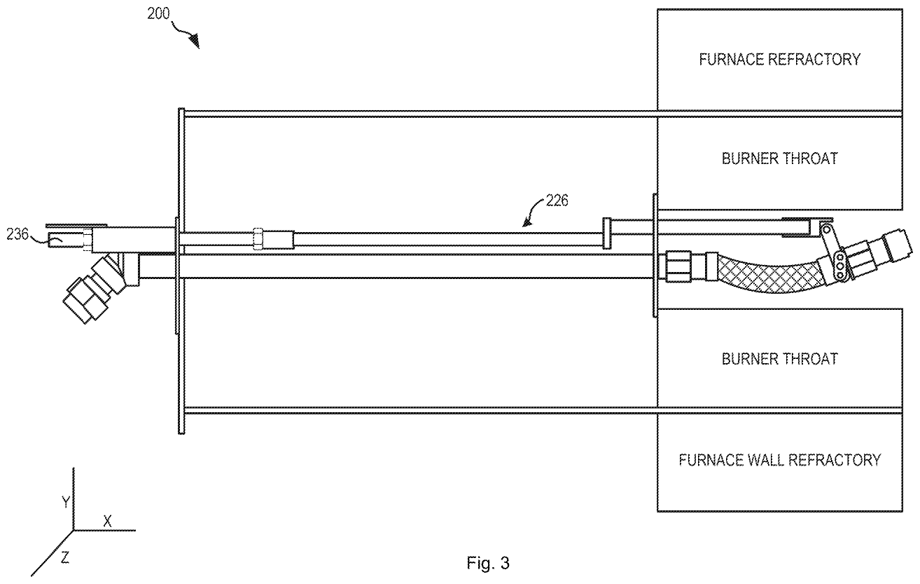

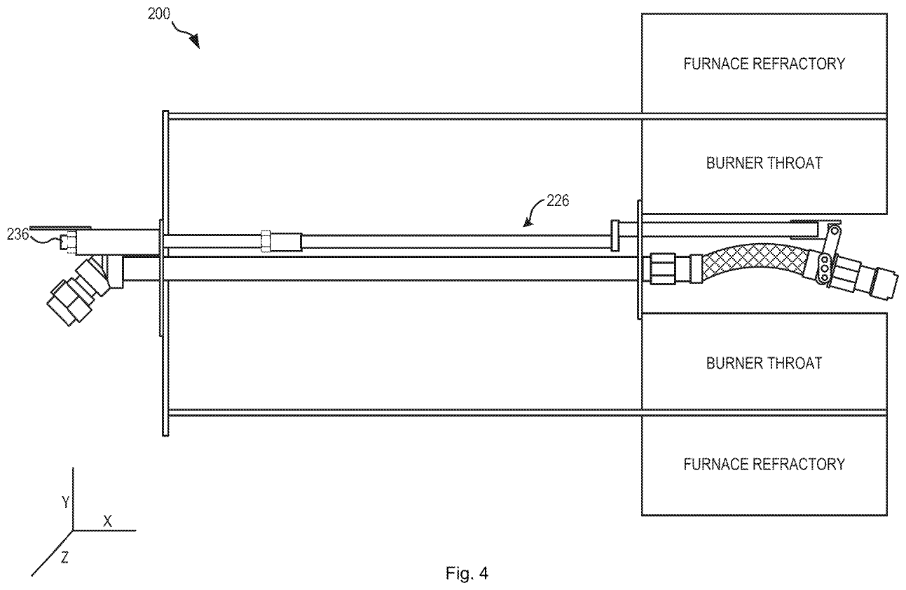

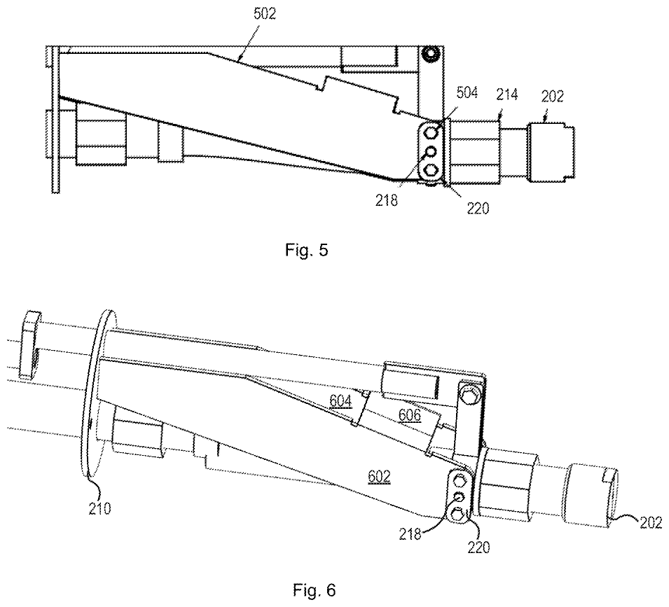

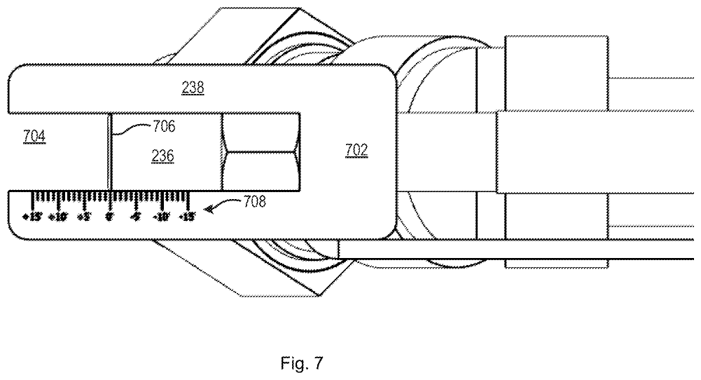

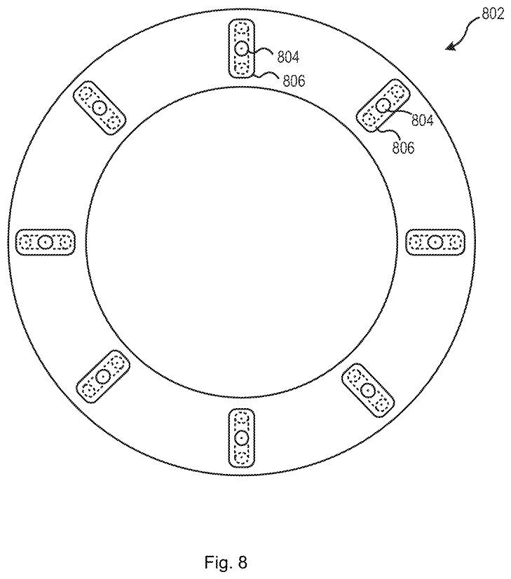

FIG. 2 depicts an example variable-direction burner tip assembly 200, in embodiments. FIG. 3 depicts the variable-direction burner tip assembly 200 angled to a first firing direction. FIG. 4 depicts the variable-direction burner tip assembly 200 angled to a second firing direction. FIG. 5 depicts a portion of the variable-direction burner tip assembly in further detail, showing the support brace coupling to the hinge where the burner tip rotates, in embodiments. FIG. 6 depicts the variable-direction burner tip assembly 200 including a support brace for supporting a hinge thereof in further detail, in embodiments. FIG. 7 depicts the rotation indicator of FIG. 2 in further detail, in embodiments. FIG. 8 depicts a front view of the exit port of a burner 802 incorporating at least one of the variable-direction burner tip assembly 200 of FIG. 2, in embodiments. FIGS. 2-5 are best viewed together with the following description.

The variable-direction burner tip assembly 200 includes a variable-direction burner tip 202 that is coupled, directly or indirectly, with a fuel input 204. Fuel input 204 is shown angled with respect to the X-axis, but it may be parallel thereto without departing from the scope hereof. The fuel input 204 is coupled to a rigid pipe 206, such as a steel gas pipe that is of the standard piping used in a combustion system burner. The rigid pipe 206 spans a first mounting plate 208 and a second mounting plate 210. The rigid pipe 206 may pass through the first mounting plate 208 and/or the second mounting plate 210, as shown in FIG. 2. Alternatively, the mounting plates 208 and 210 may include coupling mechanisms for securing to the rigid pipe 206. The rigid pipe 206 is coupled to a flexible hose 212 that couples to the burner tip 202 via a hose coupler 214 (which is shown as a nut). The flexible hose 212 may be a braided steel hose. In the figures herein, the side at which the burner tip 202 is located is referred to as the combustion-zone side, and the side at which the actuator is located is referred to as an exterior side.

The hose coupler 214 (or another portion of the burner tip 202) is coupled to a rotator assembly 216. The rotator assembly 216 is a mechanical or electrical (e.g., servo) device that varies the direction of the burner tip 202. The rotator assembly 216 is shown as a mechanical rotator that varies the direction of the burner tip 202 in the Y-axis. However, the rotator assembly 216 may be a different type of mechanical rotator, that rotates the burner tip 202 about more than one axis, such as each of the X-, Y-, and Z-axis. Moreover, the rotator may include a translation component that moves the burner tip 202 along one or more of the X-, Y-, and Z-axis (e.g., that moves the burner tip 202 further into the combustion system space, or back into the burner housing).

In FIGS. 2-6, the rotator assembly 216 is shown as a mechanical linkage that permits rotation of the burner tip 202 about first hinge bar 218 to rotate the burner tip 202 about the Z axis along the Y axis (e.g., so that the burner tip 202 points upward or downward depending on the actuation of the mechanical linkage). The first hinge bar 218 may be a plurality of protrusions aligned to one another on a hinge-axis from the hose coupler 214 that are located in a plurality of apertures of an optional support brace 502 and optionally a hinge plate 220, shown in FIG. 5 and discussed below. The rotator assembly 216 includes the hinge plate 220 coupled via one or more fasteners 504. A support plate 502 may be utilized for additional mechanical stiffening via attachment between hinge plate 220 and rotator assembly 216. Hinge plate 220 supports the first hinge bar 218. A first linkage arm 222 couples between first hinge bar 218 and second hinge bar 224. First linkage arm 222 is fixedly positioned with respect to the burner tip 202 such that rotation of the first linkage arm 222 about first hinge bar 218 causes the direction of the burner tip 202 to vary.

The support brace 502 is fixedly mounted to the second mounting plate 210, and thus maintains the first hinge bar 218 at a given location. The support brace 502 includes a first side 602 and a second side 604 coupled to the second mounting plate 210. The first and second sides 602 and 604 are also supported to each other via a top plate 606.

The first linkage arm 222 is coupled to a second linkage arm 226. The second linkage arm 226 is shown including a linkage-arm coupler 228, a first linkage-arm component 230, an off-set plate 232, and a second linkage-arm component 234. Second linkage arm 226 is further coupled to an actuator 236.

Second linkage arm 226 may be a metal rod, plate, or any other mechanical device that allows for horizontal movement of the second linkage arm 226 in response to interaction with actuator 236, as discussed below. Off-set plate 232 allows for a greater vertical spacing (e.g., along Y-axis in FIG. 2) between first hinge bar 218 and second hinge bar 224, thus translating to specific directional variation the firing direction in response to horizontal movement (e.g., along X-axis in FIG. 2) of the second linkage arm 226. The configuration of first linkage arm component 230, off-set plate 232, and second linkage-arm component 234 may be different than shown depending on the particular application of the variable-direction burner tip 200. Moreover, second linkage arm 226 may be a single rod without the off-set plate 232, without departing from the scope hereof.

Actuator 236 is a threaded rod (or otherwise a nut) coupled to the second linkage arm 226 via an actuator coupler 239. As the actuator 236 is rotated in a clockwise or counterclockwise direction, the second linkage arm 226 translates along the X-axis. FIG. 3 depicts the second linkage arm 226 translated horizontally to the left in FIGS. 2-4 (e.g., toward the actuator 236), causing the burner tip 202 to rotate upward in the Y-direction. FIG. 4 depicts the second linkage arm 226 translated horizontally to the right in FIGS. 2-4 (e.g., toward the actuator 236), causing the burner tip 220 to rotate downward in the Y-direction.

The variable-direction burner tip assembly 200 may further include a rotation indicator 238. The rotation indicator 238 correlates the position of the actuator 236 to the firing direction of the burner tip 202. Because the burner tip 202 is in the heater, it is not readily visible to the operator. Therefore, the rotation indicator 238 allows the operator to understand the position of the burner tip 202. FIG. 6 depicts one example of the rotation indicator 238. The rotation indicator 238 is a plate 702 that is proximate the actuator 236. The plate 702 includes a notch 704 that allows visual inspection of alignment of an edge 706 with one or more markings 708 that indicate the value of rotation of the burner tip 202. The edge 706 need not be an edge, but instead may be a marking on the actuator 236. Furthermore, the rotation indicator 238 is shown as a manual indicator. However, it should be appreciated that the rotation indicator may also be an electronic indicator in some embodiments, where a sensor can detect the position of the actuator and transmit, via wired or wireless connection, the burner tip direction or the sensed position of the actuator to an external device (such as the heater controller 124).

Referring back to FIG. 2, the first mounting plate 208 is coupled to a front plate 240 of the burner housing. The burner housing may further include one or more side plates 242. The first mounting plate 208 may, in some embodiments, be integral to or the same component as the front plate 240. Surrounding the burner tip (and any additional internal components, such as components from the burner tip 202 to the second mounting plate 210) is the burner throat 244. The burner throat 244 may comprise metal or refractory material, or other heat-resistant material. The burner throat 244 comprises one or more apertures 246 for the burner tip 202 to extend through and thus be positioned to inject fuel into the combustion system. FIG. 8 depicts a burner 802 that incorporates eight separate variable-direction burner tips 804, which are examples of variable-direction burner tip 202. The apertures 806, which are examples of the aperture 246, may be over-sized to accommodate the range of motion and pointing directions of the burner tip 202 when the actuator 236 is actuated.

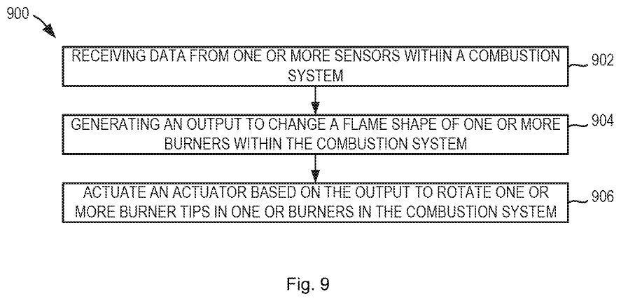

FIG. 9 depicts a method 900 for changing a flame shape within a combustion system using a variable-direction burner tip and burner incorporating the same, in embodiments. Method 900 may be implemented manually using the variable-direction burner tip 200 discussed above with respect to FIGS. 2-8, or electronically via execution by a processor of burner controller software instructions that electronically control an actuator.

In block 902, method 900 receives data from one or more sensors within a combustion system. In one example of block 902, the heater controller 124 receives, and stores within sensor database 126, data from one or more of the sensors 122 within the combustion system 100 defining operating conditions of the combustion system.

In block 904, method 900 outputs a control signal to change a flame shape of one or more burners within the combustion system. In one example of operation of block 904, the heater controller 124 outputs a control signal 128 to change the flame shape output by burner 102.

In block 906, the method 900 actuates at least one actuator to vary direction of one or more burner tips on one or more burners within the combustion system. In one example of operation of block 906, the actuator 236 is manually rotated to vary the position of the burner tip 202 to a desired pointing direction as indicated by rotation indicator 238. The control signal from block 904 may indicate the amount of actuation of actuator 236 may be displayed to the operator one a display of an operator device (e.g., control display on heater controller 124, display on a mobile operator device such as a tablet or smartphone, etc.). In one example of operation of block 906, the actuator 236 is electronically rotated based on the control signal from block 904.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween. Examples of combination of features are as follows:

### Combination of Features:

The above described features may be combined in any manner without departing from the scope hereof. The below combination of features includes examples of such combinations, where any feature described above may also be combined with any embodiment of the aspects described below.

(A1) In an embodiment of a first aspect, a burner having variable-direction burner tip, includes: a burner throat having one or more burner throats therein, the burner throats; a burner tip positioned within the burner throat, the burner tip coupled to a first actuator that, when actuated, alters a firing direction of the burner tip; and a flexible hose coupling a fuel input to the burner tip to accommodate rotation of the burner tip.

(A2) In the embodiment (A1), the actuator is coupled to a mechanical arm that, when actuated, alters the firing direction along a first axis.

(A3) In either embodiment (A1)-(A2), the actuator is coupled to a mechanical arm that, when actuated, alters the firing direction along one or more of a first axis, a second axis orthogonal to the first axis, and a third axis orthogonal to the first and second axis.

(A4) In any of the embodiments (A1)-(A3), the actuator is coupled to a mechanical arm, the mechanical arm comprising: a first linkage arm coupled between a first hinge bar and a second hinge bar, the first hinge bar; and a second linkage arm coupled between the second hinge bar and the actuator

(A5) In any of the embodiments of (A4), the first hinge bar coupled to a hose coupler attached to the burner tip, the hose coupler coupled with the fuel input via the flexible hose.

(A6) In any of the embodiments (A4)-(A5), the first hinge bar including a plurality of protrusions, aligned to one another along a hinge axis, and extending from the hose coupler.

(A7) In any of the embodiments (A4)-(A6), the first hinge bar being located in a plurality of apertures of a support brace fixedly mounted to a mounting component of the burner.

(A8) In any of the embodiments (A4)-(A7), the mounting component being a mounting plate, wherein the mechanical arm extends through the mounting plate.

(A9) In any of the embodiments (A4)-(A8), the first hinge bar coupled to a mounting plate.

(A10) In any of the embodiments (A4)-(A9), the second linkage arm including a first linkage-arm component and a second linkage-arm component coupled to the first linkage-arm component via an off-set plate such that the first linkage-arm component is off-set from the second linkage-arm component.

(A11) In any of the embodiments (A1)-(A10), further comprising a rotation indicator that correlates the position of the actuator to the firing direction of the burner tip.

(A12) In any of the embodiments (A11), the rotation indicator including a plate proximate the actuator including a plurality of markings indicating the value of rotation of the burner tip.

(A13) In any of the embodiments (A11)-(A12), the rotation indicator including a sensor that senses the position of the actuator and transmits the potion to an external device.

(A14) In any of the embodiments (A1)-(A13), the flexible hose comprising a braided-steel hose.

(B1) In an embodiment of a second aspect, a variable-direction burner tip, includes: an actuator; a burner tip; a linkage coupled between the actuator and the burner tip that, in response to actuation of the actuator, alters the firing direction of the burner tip; and a flexible hose directly or indirectly coupling the burner tip to a fuel input coupler.

(B2) In the embodiment (B1), further including a first mounting plate; and a second mounting plate; the actuator being located on an exterior side of the first mounting plate; the burner tip being located on a combustion-zone side of the second mounting plate, the combustion-zone side opposing the exterior side.

(B3) In either embodiment (B1)-(B2), the actuator coupled to a mechanical arm that, when actuated, alters the firing direction along a first axis.

(B4) In any of the embodiments (B1)-(B3), the actuator coupled to a mechanical arm that, when actuated, alters the firing direction along one or more of a first axis, a second axis orthogonal to the first axis, and a third axis orthogonal to the first and second axis.

(B5) In any of the embodiments (B1)-(B4), the actuator coupled to a mechanical arm, the mechanical arm including: a first linkage arm coupled between a first hinge bar and a second hinge bar, the first hinge bar; and a second linkage arm coupled between the second hinge bar and the actuator.

(B6) In any of the embodiments (B1)-(B5), the first hinge bar coupled to a hose coupler attached to the burner tip, the hose coupler coupled with the fuel input via the flexible hose.

(B7) In any of the embodiments (B1)-(B6), the first hinge bar being located in a plurality of apertures of a support brace fixedly mounted to a mounting component of the burner.

(B8) In any of the embodiments (B1)-(B7), the second linkage arm including a first linkage-arm component and a second linkage-arm component coupled to the first linkage-arm component via an off-set plate such that the first linkage-arm component is off-set from the second linkage-arm component.

(B9) In any of the embodiments (B1)-(B8), a rotation indicator that correlates the position of the actuator to the firing direction of the burner tip.

(B10) In any of the embodiments (B9), the rotation indicator including a plate proximate the actuator including a plurality of markings indicating the value of rotation of the burner tip.

(B11) In any of the embodiments (B9)-(B10), the rotation indicator including a sensor that senses the position of the actuator and transmits the potion to an external device.

(B12) In any of the embodiments (B1)-(B11), the flexible hose comprising a braided-steel hose.

(C1) In an embodiment of a third aspect, a method for varying firing direction of a burner tip, including: actuating an actuator coupled to a variable-direction burner tip via a mechanical arm, the mechanical arm including: a first linkage coupled between a first hinge bar coupled to the burner tip and a second hinge bar coupled, and a second linkage coupled between the second hinge bar and the actuator.

(C2) In the embodiment (C1), further including: receiving data from one or more sensors within the combustion system, the data defining operating conditions of the operating system; and outputting a control signal based on the data; wherein the actuating is based on the control signal.(C3) In any of the embodiments (C1)-(C2), the actuating comprising electronically actuating the actuator based on the control signal.

What is claimed is:

1. A burner having variable-direction burner tip, comprising:
a burner throat having one or more burner throats therein, the burner throats being sized and shaped to accommodate variation in firing direction by at least one burner tip positioned within each of the burner throats;
each of the burner tips coupled to a first actuator that, when actuated, alters a firing direction of the burner tip; and
a respective flexible hose coupling a fuel input to each the burner tip to accommodate rotation of the respective burner tip.

2. The burner of claim 1, the actuator coupled to a mechanical arm that, when actuated, alters the firing direction along a first axis.

3. The burner of claim 1, the actuator coupled to a mechanical arm that, when actuated, alters the firing direction along one or more of a first axis, a second axis orthogonal to the first axis, and a third axis orthogonal to the first and second axis.

4. The burner of claim 1, the actuator coupled to a mechanical arm, the mechanical arm comprising:
a first linkage arm coupled between a first hinge bar and a second hinge bar, the first hinge bar; and
a second linkage arm coupled between the second hinge bar and the actuator.

5. The burner of claim 4, the first hinge bar coupled to a hose coupler attached to the burner tip, the hose coupler coupled with the fuel input via the flexible hose.

6. The burner of claim 5, the first hinge bar including a plurality of protrusions, aligned to one another along a hinge axis, and extending from the hose coupler.

7. The burner of claim 4, the first hinge bar being located in a plurality of apertures of a support brace fixedly mounted to a mounting component of the burner.

8. The burner of claim 7, the mounting component being a mounting plate, wherein the mechanical arm extends through the mounting plate.

9. The burner of claim 7, the first hinge bar coupled to a mounting plate.

10. The burner of claim 4, the second linkage arm including a first linkage-arm component and a second linkage-arm component coupled to the first linkage-arm component via an off-set plate such that the first linkage-arm component is off-set from the second linkage-arm component.

11. The burner of claim 1, further comprising a rotation indicator that correlates the position of the actuator to the firing direction of the burner tip.

12. The burner of claim 11, the rotation indicator including a plate proximate the actuator including a plurality of markings indicating the value of rotation of the burner tip.

13. The burner of claim 11, the rotation indicator including a sensor that senses the position of the actuator and transmits the potion to an external device.

14. The burner of claim 1, the flexible hose comprising a braided-steel hose.

15. A variable-direction burner tip, comprising:
an actuator;
a burner tip;
a linkage coupled between the actuator and the burner tip that, in response to actuation of the actuator, alters the firing direction of the burner tip; and
a flexible hose directly or indirectly coupling the burner tip to a fuel input coupler.

16. The burner tip of claim 15, further comprising:
a first mounting plate; and
a second mounting plate;
the actuator being located on an exterior side of the first mounting plate;
the burner tip being located on a combustion-zone side of the second mounting plate, the combustion-zone side opposing the exterior side.

17. The burner tip of claim 15, the actuator coupled to a mechanical arm that, when actuated, alters the firing direction along a first axis.

18. The burner tip of claim 15, the actuator coupled to a mechanical arm that, when actuated, alters the firing direction along one or more of a first axis, a second axis orthogonal to the first axis, and a third axis orthogonal to the first and second axis.

19. The burner tip of claim 15, the actuator coupled to a mechanical arm, the mechanical arm comprising:
a first linkage arm coupled between a first hinge bar and a second hinge bar, the first hinge bar; and
a second linkage arm coupled between the second hinge bar and the actuator.

20. The burner tip of claim 19, the first hinge bar coupled to a hose coupler attached to the burner tip, the hose coupler coupled with the fuel input via the flexible hose.

21. The burner tip of claim 20, the first hinge bar including a plurality of protrusions, aligned to one another along a hinge axis, and extending from the hose coupler.

22. The burner tip of claim 20, the first hinge bar being located in a plurality of apertures of a support brace fixedly mounted to a mounting component of the burner.

23. The burner tip of claim 20, the second linkage arm including a first linkage-arm component and a second linkage-arm component coupled to the first linkage-arm component via an off-set plate such that the first linkage-arm component is off-set from the second linkage-arm component.

24. The burner tip of claim 15, further comprising a rotation indicator that correlates the position of the actuator to the firing direction of the burner tip.

25. The burner tip of claim 24, the rotation indicator including a plate proximate the actuator including a plurality of markings indicating the value of rotation of the burner tip.

26. The burner tip of claim 24, the rotation indicator including a sensor that senses the position of the actuator and transmits the potion to an external device.

27. The burner tip of claim 15, the flexible hose comprising a braided-steel hose.

28. A method for varying firing direction of a burner tip, comprising:
actuating an actuator coupled to a variable-direction burner tip via a mechanical arm, the mechanical arm including:
a first linkage coupled between a first hinge bar coupled to the burner tip and a second hinge bar coupled, and
a second linkage coupled between the second hinge bar and the actuator.

29. The method of claim 28, further comprising:
receiving data from one or more sensors within the combustion system, the data defining operating conditions of the operating system; and
outputting a control signal based on the data;
wherein the actuating is based on the control signal.

30. The method of claim 29, the actuating comprising electronically actuating the actuator based on the control signal.
